(19) United States
(12) Patent Application Publication
(10) Pub. No.: US 2010/0127529 A1
(43) Pub. Date: May 27, 2010

(54) Vehicle storage cover assembly

(76) Inventors: Adrian Nicholas Alexander Elliott, Dearborn, MI (US); Pete Moceri, Macomb, MI (US); Kelly Michael Kohlstrand, Wyandotte, MI (US); Daniel E. Sutter, Almont, MI (US); Samir K. Raval, New Boston, MI (US)

Correspondence Address: DYKEMA GOSSETT PLLC, 39577 WOODWARD AVENUE, SUITE 300, BLOOMFIELD HILLS, MI, 48304, US

(21) Appl. No.: 12/275,908

(22) Filed: Nov. 21, 2008

(51) Int. Cl. B60P 7/02

(52) U.S. Cl. 296/100.09; 296/100.17; 296/100.06

(57) ABSTRACT

A vehicle storage cover assembly includes a truck having a cab, a cab rear window, an open top cargo bed and a headboard, with the headboard being located below the cab rear window. A box frame is operatively mounted on the open top cargo bed; and a divider panel is operatively configured to be affixed within the box frame. A foldable cargo bed cover is operatively configured to mount on the box frame in at least one of a first partially open position, a second partially open position, a third partially open position, a fully closed position, or a stowed position. The foldable cargo bed cover is configured for stowage within a chamber defined by the box frame and the divider panel.

### BACKGROUND

The present disclosure relates generally to a foldable cover for a truck bed.

Trucks, in particular pickup trucks, are widely used on roads. One of the reasons for the popularity of the pickup truck is that such vehicles provide a great deal of versatility, especially when they are used in conjunction with a business.

As is known in the automotive industry, there is a desire to use pickup trucks for both business and personal applications. For example, trucks may be used during business hours to haul merchandise, materials, or goods; and then be converted for personal use during the evenings and weekends. Given that it is sometimes necessary to transport both business and personal goods, or personal belongings that are particularly susceptible to theft, there is a need for covering the bed to protect its contents. Moreover, the cargo space of the conventional pickup truck is open, and, therefore, the contents of the truck bed are unprotected from the weather.

Accordingly, pickup truck beds have typically been covered by a tonneau type cover which may be formed of cloth and has peripheral snaps that attach to corresponding snaps located on the side wall of the bed. Another type of cover includes a single panel or multi-panel cover of molded rigid fiberglass or plastic bolted or otherwise fastened to the truck bed sidewalls. Multi-panel covers can open to provide access to the cargo bed by raising one or both panels. Where there is a rigid roof structure, this rigid roof structure is placed over the truck bed, and bolted, clamped or otherwise rigidly secured to the truck bed. This type of structure normally has a rear door which is positioned above, and cooperates with the tailgate of the cargo space. Access to such cargo area of the truck bed may be exclusively through the rear opening provided by pivoting the rear door and tailgate panel to the open position.

Moreover, rigid fiberglass or plastic covers are stored external to the vehicle, and do not provide a user with much flexibility in storing large personal items in the vehicle cargo bed. The user is generally required to store traditional fiberglass covers external to the vehicle, such as in one's garage, or in an open bed of a vehicle. This may in some instances subject the cover to unnecessary wear and tear, potential theft or loss of the cover, and (when stored in the vehicle bed) unnecessarily fills space that could be more efficiently used.

### SUMMARY

A vehicle storage cover assembly according to embodiment(s) disclosed herein includes a truck having a cab, a cab rear window, an open top cargo bed and a headboard, with the headboard being located below the cab rear window. A box frame is operatively mounted on the open top cargo bed; and a divider panel is operatively configured to be affixed within the box frame. A foldable cargo bed cover is operatively configured to mount on the box frame in at least one of a first partially open position, a second partially open position, a third partially open position, a fully closed position, or a stowed position. The foldable cargo bed cover is configured for stowage within a chamber defined by the box frame and the divider panel.

### BRIEF DESCRIPTION OF THE DRAWINGS

Features and advantages of embodiments of the present disclosure will become apparent by reference to the following detailed description and drawings, in which like reference numerals correspond to similar, though perhaps not identical, components. For the sake of brevity, reference numerals or features having a previously described function may or may not be described in connection with other drawings in which they appear.

FIG. 1 is a cutaway perspective view of an embodiment of a vehicle cargo bed cover of the present disclosure, shown installed on a truck and in the closed position;

FIG. 2 is a cutaway perspective view similar to FIG. 1, but showing the vehicle cargo bed cover being folded open as it is moved to a third partially open position;

FIG. 3 is a cutaway perspective view similar to FIG. 1, but showing the vehicle cargo bed cover in the third partially open position;

FIG. 4 is a cutaway perspective view similar to FIG. 1, but showing the vehicle cargo bed cover in the first partially open position;

FIG. 5 is an enlarged, cutaway perspective view of an embodiment of the vehicle cargo bed cover in the second partially open position; and

FIG. 6 is an enlarged, cutaway, perspective side view of an embodiment of the vehicle cargo bed cover in the stowed position.

### DETAILED DESCRIPTION

Accordingly, the aforementioned systems have the disadvantage of complexity and operational inconvenience, particularly when the user seeks to store the cover and have full use of the truck bed; and/or when a user seeks to securely store objects of varying size.

The present disclosure provides a simple yet flexible vehicle cargo bed cover 10 which can advantageously provide both open and closed cargo areas, as well as stow away when desired, thereby allowing substantially full use of the open cargo bed 12 when the vehicle cargo bed cover 10 is not in use.

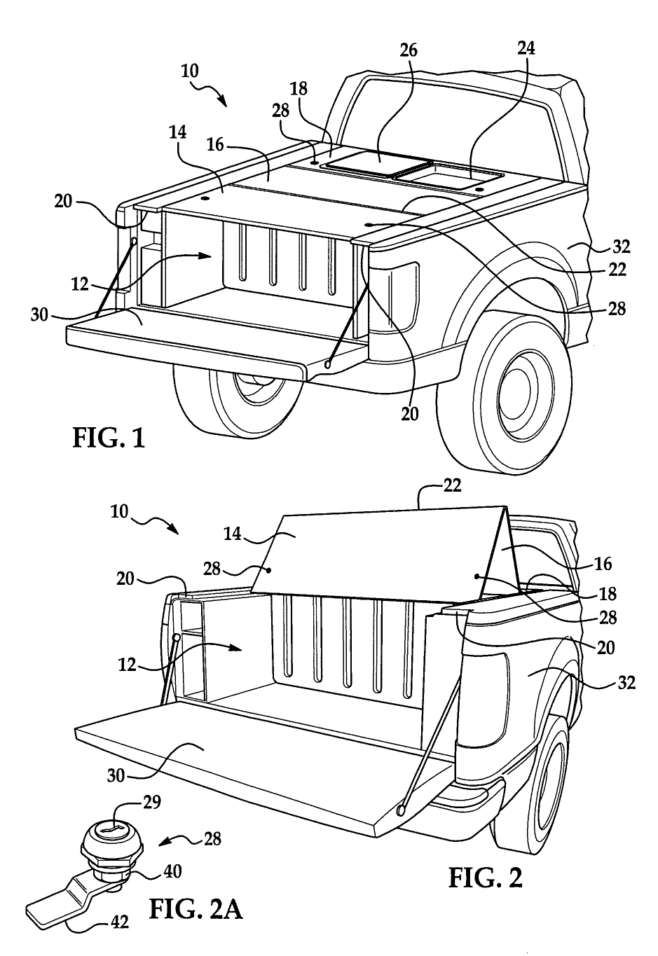

Referring now to FIG. 1, the vehicle cargo bed cover 10 is illustrated in the closed position. This closed position may generally be preferred when a vehicle user wishes to provide locked and protected storage of goods wherein the goods stored within the cargo bed 12 will be sheltered from weather or potential theft. As shown in the non-limiting example of FIG. 1, an embodiment of the vehicle cargo bed cover 10 may include first panel 14, second panel 16, and third panel 18, each of which is removably attached to the box frame 20, thereby resulting in a completely covered cargo bed 12 area. It is to be understood that the box frame 20 is generally the area of the vehicle 32 that is mounted onto the truck bed 12. The box frame 20 includes body structural members such as, e.g., the D-Pillar, bed rails and side walls of the vehicle truck bed 12.

The first panel 14 and second panel 16 are pivotally attached to one another. As shown in FIG. 1, suitable hinge(s), such as a piano hinge 22, may provide the pivotal attachment between the first panel 14 and the second panel 16. However, it is to be understood that a variety of mechanisms may be used to provide pivotal attachment between the first panel 14 and the second panel 16. Moreover, the second panel 16 is also shown as being pivotally attached to the third panel 18. Again, FIG. 1 illustrates a piano hinge 22 as a non-limiting example as a means for pivotal attachment. However, it is to be understood that a variety of mechanisms may be used to provide the pivotal attachment between the second panel 16 and the third panel 18. Examples of such suitable mechanisms include, but are not limited to piano hinges, living hinges, other suitable hinges, and combinations thereof.

As shown in FIG. 1, third panel 18 may include storage units 24 which are integral with third panel 18. Third panel 18 has storage units 24 which have lids 26 which are pivotally attached to the storage unit 24 and/or third panel 18. FIG. 1 illustrates one of the integral storage units 24 with the lid 26 open. Accordingly, by having the larger cargo bed 12 area covered by the foldable cover 10 and small objects stored in the storage area(s) 24, a user of such a vehicle 32 may have covered storage for large items in the bed 12 of the vehicle 32 as well as covered storage for smaller items in the storage units 24 of third panel 18. It is to be understood that storage unit 24 may be integrated as part of any one or more of panels 14, 16, 18 of cargo bed cover 10, and that the implementation of storage unit 24 in third panel 18 is a non-limiting example.

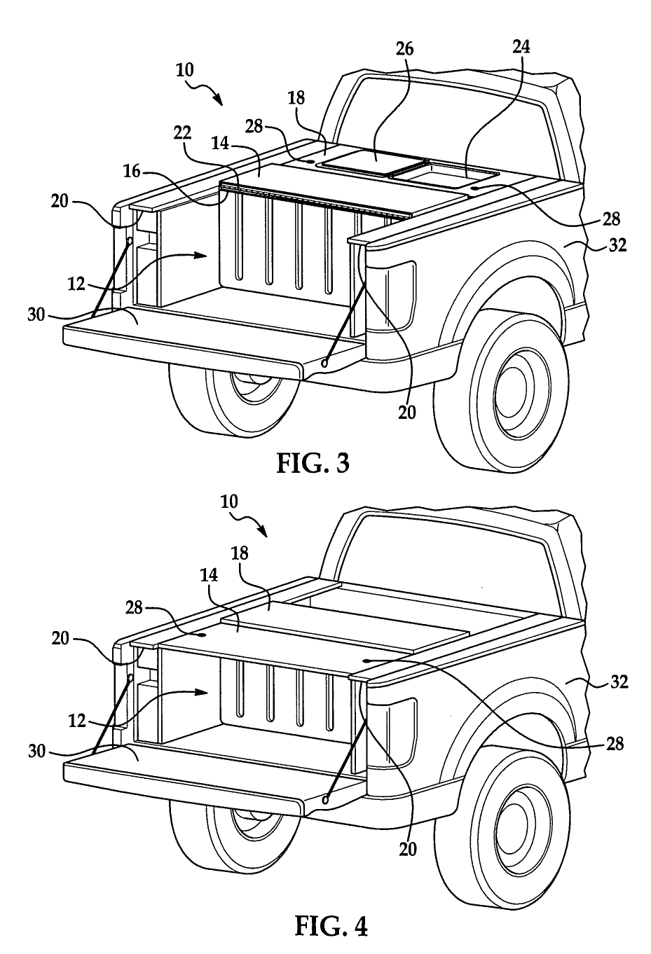

Referring now to FIGS. 2 and 3, the first panel 14 and the second panel 16 are being pivoted upward to illustrate pivotal connection between the first panel 14 and the second panel 16, as well as pivotal connection between the second panel 16 and the third panel 18. As shown, each of the three panels may include a locking mechanism 28 which cooperates with the box frame 20 to affix each of the first panel 14, second panel 16 and third panel 18 to the box frame 20.

It is to be understood that the locking mechanism 28 may be a variety of different mechanisms. One non-limiting example of locking mechanism 28 includes a keyed lock arm 42 as shown in FIG. 2A. Locking mechanisms 28 may connect panels 14, 16, 18 to the box frame 20. A uniquely configured recess 29 within the locking mechanism 28 may receive and mate with a key (not shown) wherein the lock 28 is rotated by key (not shown). As is shown in FIGS. 1-3, locking mechanisms 28 are disposed in each of the first panel 14, the second panel 16 and the third panel 18. Each panel 14, 16, 18 may include a lock receiving recess/bore (not shown) which receives the lock 28. Each locking mechanism 28 may be rotationally affixed or integral with an arm 42 which is disposed on the opposite side of the panel 14, 16, 18 such that when the key (not shown) rotates the locking mechanism 28 and the corresponding arm 42. The arm 42 is pivoted to interlock with the box frame 20 or pivoted to disengage with the box frame 20.

It is to be understood that a sliding member (not shown) may be used instead of a rotating member in order to have the cargo bed cover 10 interlock with the box frame 20. Moreover, it is also to be understood that the sliding member (not shown), rotating member, interlocking member, such as arm 42 of locking mechanism 28 or the like may be disposed on either the cover 10 as shown in FIG. 2 or may be disposed on the box frame 20 and/or tailgate 30 of the vehicle 32.

Referring now to FIG. 4, the vehicle bed cover 10 assembly is shown in a first partially open position where the first panel 14 remains pivotally attached to the second panel 16, and the third panel 18 is disposed on the second panel 16. As shown in FIG. 4, in this embodiment, third panel 18 differs from previous figures in that third panel 18 does not have an integrated storage unit 24.

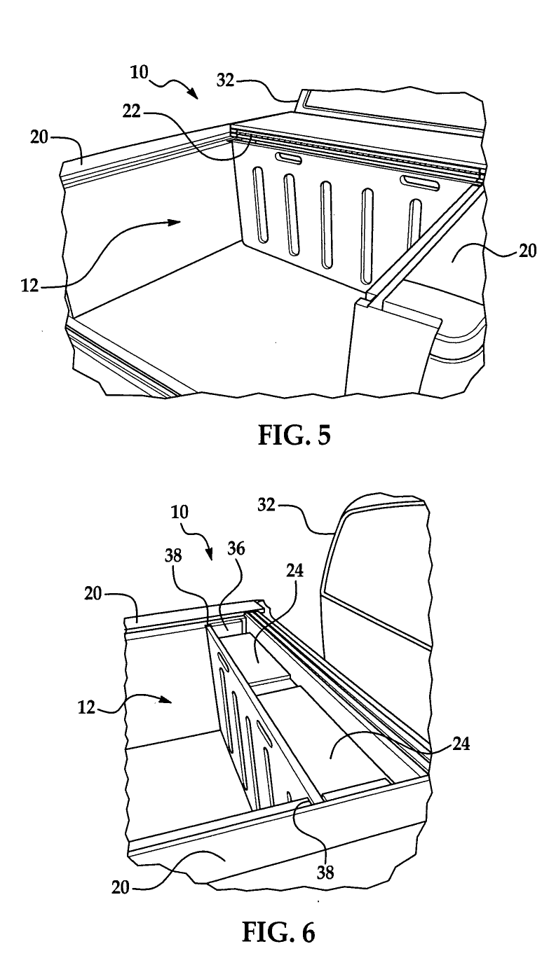

Referring now to FIG. 5, in the second partially open position, the second panel 16 remains pivotally attached to the third panel 18, and the second panel 16, in turn, is disposed on the third panel 18. The divider panel 34 may be inserted so that divider panel 34 creates a smaller closed compartment with the folded first, second, and third panels 14, 16, 18 (respectively) operating as a cover 10, and the box frame 20 forming side walls with the divider panel 34 so as to define the smaller closed compartment 37.

Referring now to FIG. 6, the vehicle bed cover 10 assembly is shown in the stowed position where the first panel 14, the second panel 16 and the third panel 18 are folded upon each other and disposed within the chamber 36 defined by the divider panel 34 and the box frame 20. As a non-limiting example, the divider panel 34 is held in place by the box frame 20 via an interlock between the divider panel 34 and recesses 38 formed within the composite box frame 20. However, it is to be understood that there are a variety of means by which the divider panel 34 could be positioned relative to the box frame 20. Some of these means include, but are not limited to mechanical fasteners, interlocking mechanisms (an example of which is shown), and the like, and combinations thereof. It is further to be understood that the box frame 20 may be formed of any suitable material as desired, some non-limiting examples of which include polymeric materials, metallic materials, metallic alloys, mixtures of metallic/composite materials, or the like, or combinations thereof, depending on the vehicle 32.

One benefit of the stowed position of FIG. 6, is that the user of a vehicle 32 is no longer required to stow the vehicle bed cover 10 external to the vehicle 32 (such as a garage), or inside the vehicle passenger area, or unsecured in the open bed 12 itself. This allows for neat and compact storage of the bed cover 10 while also allowing the vehicle user access to and use of a substantial area of the entire vehicle cargo bed 12. There may advantageously be a reduced potential for damage to, or loss of the bed cover 10 in this stowed position.

While several embodiments have been described in detail, it will be apparent to those skilled in the art that the disclosed embodiments may be modified. Therefore, the foregoing description is to be considered exemplary rather than limiting.

What is claimed is:

1. A vehicle storage cover assembly, comprising:
a truck having a cab, a cab rear window, an open top cargo bed and a headboard, the headboard being located below the cab rear window;
a box frame operatively mounted on the open top cargo bed;
a divider panel operatively configured to be affixed within the box frame; and
a foldable cargo bed cover operatively configured to mount on the box frame in at least one of a first partially open position, a second partially open position, a third partially open position, a fully closed position, or a stowed position, the foldable cargo bed cover being configured for stowage within a chamber defined by the box frame and the divider panel.

2. The vehicle storage cover assembly as defined in claim 1 wherein the box frame includes a plurality of composite side panels, the plurality of side panels defining recesses operatively configured to receive a respective adjacent edge of the divider panel.

3. The vehicle storage cover assembly as defined in claim 1 wherein the foldable cargo bed cover further comprises at least one storage unit integral with a panel of the foldable cargo bed cover.

4. The vehicle storage cover assembly as defined in claim 1 wherein the foldable cargo bed cover includes a first panel, a second panel, and a third panel, the first, second and third panels being pivotally connected to one another.

5. The vehicle storage cover assembly as defined in claim 4 wherein the first, second and third panels are pivotally connected to one another by two piano hinges, each hinge operatively connected to adjacent respective panels.

6. The vehicle storage cover assembly as defined in claim 4 wherein when in the first partially open position, the first panel is disposed directly upon the second panel, and the second panel and the third panel are each removably attached directly on the box frame.

7. The vehicle storage cover assembly as defined in claim 4 wherein when in the second partially open position, the third panel is disposed directly upon the second panel, and the second panel and the first panel are each removably attached directly on the box frame.

8. The vehicle storage cover assembly as defined in claim 4 wherein when in the third partially open position, the first panel is disposed directly on the second panel, and the second panel is disposed directly on the third panel, and the third panel is removably attached directly on the box frame.

9. The vehicle storage cover assembly as defined in claim 4 wherein when in the closed position, the first panel, the second panel, and the third panel are each removably attached directly on the box frame.

10. The vehicle storage cover assembly as defined in claim 4 wherein when in the stowed position, the foldable cargo bed cover is placed in the chamber.

11. A storage cover assembly, comprising:
a first panel pivotally connected to a second panel; and
a third panel pivotally connected to the second panel, the third panel having a storage unit integral therewith, wherein each of the first panel, the second panel, and the third panel are operatively configured to attach to a vehicle truck bed.

12. The storage cover assembly as defined in claim 11 wherein the storage unit comprises a lid pivotally attached thereto, the lid being operatively disposed within a recess defined by the third panel.

13. The storage cover assembly as defined in claim 11, further comprising a divider panel disposed substantially perpendicularly to the first panel, the second panel and the third panel when at least one of the first panel, the second panel, or the third panel are removably attached to the vehicle truck bed.

14. The storage cover assembly as defined in claim 11 wherein the first panel, the second panel and the third panel are composite panels.

15. The storage cover assembly as defined in claim 11, further comprising:
a first piano hinge operatively configured to pivotally connect the first panel to the second panel; and
a second piano hinge operatively configured to pivotally connect the second panel to the third panel.
